(19) United States
(12) Patent Application Publication
(10) Pub. No.: US 2025/0150235 A1
(43) Pub. Date: May 8, 2025

(54) METHOD AND SYSTEM FOR SIDELINK POSITIONING PROTOCOL DATA UNIT CONFIGURATIONS, MESSAGE ENCODING AND SIGNALING

(71) Applicants: Centre of Excellence in Wireless Technology, Tamil Nadu (IN); INDIAN INSTITUTE OF TECHNOLOGY MADRAS (IIT Madras), Tamil Nadu (IN)

(72) Inventors: Jishnu Ponnappan, Tamil Nadu (IN); Abhijeet Abhimanyu Masal, Tamil Nadu (IN); Pavan Kalyan Devarakonda, Tamil Nadu (IN); Jeniston Deviraj Klutto Milleth, Tamil Nadu (IN); Bhaskar Ramamurthi, Tamil Nadu (IN)

(21) Appl. No.: 18/935,340

(22) Filed: Nov. 1, 2024

(30) Foreign Application Priority Data
Nov. 3, 2023 (IN) 202341075050

(51) Int. Cl. H04L 5/00; H04W 76/11

(52) U.S. Cl. CPC H04L 5/0051; H04W 76/11

(57) ABSTRACT

The present disclosure relates to a method (500) of obtaining location of a first user equipment (UE) wherein the method comprises, receiving (501), by a location management function (LMF), at least one location service (LCS) request from at least one second UE connected to the network, to estimate the location of the first UE. Further, the method includes identifying (502), by the LMF, at least one third UE participating in the positioning session, wherein the LMF communicates with the at least one third UE. Further the method includes, generating (503), by the LMF, at least one first sidelink positioning protocol data units (SLPP PDUs) for the at least one second UE and the at least one third UE, wherein the at least one first SLPP PDU includes at least one first session ID to the at least one LCS request.

### CROSS-REFERENCE TO RELATED APPLICATIONS

This application claims the benefit of Indian patent application Ser. No. 202341075050, filed 3 Nov. 2023 the disclosure of which is incorporated herein by reference in its entirety.

### TECHNICAL FIELD

The present disclosure relates to positioning in a wireless communication system, and more particularly to sidelink positioning in different network coverage scenarios.

### BACKGROUND

In the evolution of mobile communication, Positioning is one of the very vital features in 5G mobile communication evolution, due to its wide range of business applications. In emergency calls, positioning is emerging as an important use case due to regulatory requirements from the Federal Communications Commission (FCC). Many other critical services rely on positioning as well, with much more stringent requirements on accuracy, time to first fix, and latency. Further various commercial applications and use cases are coming up with more stringent positioning requirements in 5G and beyond systems.

Third-generation partnership project (3GPP), as well as other standard-bearing organizations, have focused on providing an accurate positioning measurement of user equipment (UE). 3GPP technology, such as Long-Term Evolution (LTE), LTE-Advanced, and 5G/New Radio (NR) gives increased importance to the sub-meter positioning accuracy of the UE. Increasing the positioning accuracy of a UE can help to protect vulnerable road users (VRUs), such as pedestrians, wheelchairs, and cyclists from vehicles, specifically autonomously driving vehicles. Protection of VRUs requires accurate sidelink positioning when a UE is not connected to at least one of the base stations (BS) or required network coverage is not available.

Therefore, there remains a need of communication architectures and signaling procedures for use in the above described different side link positioning and ranging scenarios including in-coverage, partial coverage, and out-of-coverage scenarios.

### OBJECTS OF THE DISCLOSURE

A general objective of the present disclosure is to achieve Sidelink (SL) positioning in out-of-coverage, partial coverage, and in-coverage scenarios.

Another objective of the disclosure is to provide a protocol layering structure for SL positioning.

Yet another objective of the disclosure is to define signaling flow for SL positioning.

### SUMMARY

The summary is provided to introduce aspects related to a method of Side-Link positioning, and the aspects are further described below in the detailed description. This summary is not intended to identify essential features of the claimed subject matter nor is it intended for use in determining or limiting the scope of the claimed subject matter.

In one embodiment of the disclosure, a method of obtaining location of at least one first user equipment (UE) wherein the method comprising: receiving, by a location management function (LMF), at least one location service (LCS) request from at least one second UE connected to the network, to estimate the location of the at least one first UE, identifying, by the LMF, at least one third UE participating in the positioning session, wherein the LMF communicates with the at least one third UE, generating, by the LMF, at least one first sidelink positioning protocol data units (SLPP PDUs) for the at least one second UE and the at least one third UE, wherein the at least one first SLPP PDU includes at least one first session ID to the at least one LCS request, sending, by the LMF, at least one first SLPP PDU to at least one of the at least one second UE and the at least one third UE, receiving, by the LMF, at least one second SLPP PDU, from the at least one of the at least one second UE and the at least one third UE, to estimate the location of the at least one first UE, wherein the at least one second SLPP PDU includes the at least one first session ID, sending, by the LMF, the location estimate of the at least one first UE, to the at least one second UE.

In another embodiment of the disclosure, a method of obtaining location of at least one first user equipment (UE) wherein the method comprising: transmitting, by the at least one second UE, at least one location service (LCS) request, to a location management function (LMF), receiving, by the at least one second UE, at least one first sidelink positioning protocol data units (SLPP PDUs), from the LMF, wherein the at least one first SLPP PDU includes at least one first session ID, segregating, by the at least one second UE, the at least one first SLPP PDU to construct at least one third SLPP PDU; wherein segregating the at least one first SLPP PDU to the at least one third SLPP PDU, further comprises: one of, including, by the at least one second UE, the at least one first session ID, in the at least one third SLPP PDU, and, adding, by the at least one second UE, at least one second session ID, in the at least one third SLPP PDU, and distributing, by the at least one second UE, the at least one third SLPP PDU, to the at least one third UE, receiving, by the at least one second UE, at least one fourth SLPP PDU, from the at least one third UE combining, by at least one second UE, the at least one fourth SLPP PDU, to construct at least one second SLPP PDU, sending, by the at least one second UE, the at least one second SLPP PDU, to the LMF, receiving, by the at least one second UE, the location estimate of the at least one first UE, from the LMF.

In another embodiment of the disclosure, a method for side link positioning (SL) and ranging to estimate the location of at least one first user equipment (UE), the method comprising: receiving, by at least one second UE, a ranging and SL positioning service request from at least one of at least one first UE, any other UE, and the application layer of the at least one second UE, discovering, by the at least one second UE, the at least one of at least one first SL anchor UE, at least one first SL positioning server UE, and at least one first SL located UE, selecting, by the at least one second UE, at least one of the at least one second SL anchor UE from the at least one first SL anchor UE, at least one second SL located UE from the at least one first SL located UE, and a SL positioning server UE from at least one of the at least one first SL positioning server UE and the at least one second UE, forwarding, by the at least one second UE, the ranging and SL positioning service request to the SL positioning server UE, receiving, by the at least one second UE, the location estimate of the at least one UE, from the SL positioning server UE, sending, by the at least one second UE, the location estimate of the at least one first UE, to at least one of the at least one first UE, any other UE, and the application layer of the at least one second UE.

In another embodiment of the disclosure, a method to enable the transmission and reception of sidelink positioning reference signal, the method comprising: one of; receiving, by at least one positioning server, at least one request from at least one pair of UEs, transmitting, by the at least one positioning server, at least one sequence ID, to the at least one pair of UEs, and, transmitting, by the at least one positioning server, at least one request to at least one first UE, receiving, by the at least one positioning server, at least one sequence ID, from the at least one first UE, receiving, by the at least one positioning server, at least one request from at least one second UE, transmitting, by the at least one positioning server, the at least one sequence ID to the at least one second UE.

In another embodiment of the disclosure, an apparatus for obtaining location of a first user equipment (UE), the apparatus comprises: one or more memories; and one or more processors coupled to the memories and adapted to: receive, by a location management function (LMF), at least one location service (LCS) request from at least one second UE connected to the network, to estimate the location of the first UE, identify, by the LMF, at least one third UE participating in the positioning session, wherein the LMF communicates with the at least one third UE, generate, by the LMF, at least one first sidelink positioning protocol data units (SLPP PDUs) for the at least one second UE and the at least one third UE, wherein the at least one first SLPP PDU includes at least one first session ID to the at least one LCS request, send, by the LMF, at least one first SLPP PDU to at least one of the at least one second UE and the at least one third UE, receive, by the LMF, at least one second SLPP PDU, from the at least one of the at least one second UE and the at least one third UE, to estimate the location of the first UE, wherein the at least one second SLPP PDU includes the at least one first session ID, send, by the LMF, at least one location estimate of the first UE, to the at least one second UE.

In another embodiment of the disclosure, the apparatus comprises the first UE is one of the at least one second UE, the at least one third UE, and any other UE.

In another embodiment of the disclosure, the apparatus comprises the LCS request is received by at least one second UE from at least one of the first UE, any other UE, and an application layer of the at least one second UE.

In another embodiment of the disclosure, the apparatus comprises the LMF communicates with the at least one third UE is by using one of, the Uu link; and, the at least one second UE, via the PC5 link.

In another embodiment of the disclosure, the apparatus comprises the at least one first SLPP PDU is transmitted to the at least one of the at least one second UE and the at least one third UE, through an access and mobility management function (AMF), followed by a next generation-radio access network (NG-RAN).

In another embodiment of the disclosure, the apparatus comprises: receive, by the LMF, the at least one second SLPP PDU, from the at least one of the at least one second UE and the at least one third UE, from the NG-RAN, through the AMF.

In another embodiment of the disclosure, the apparatus comprises the AMF handles the routing of the at least one first SLPP PDU to at least one of the at least one second UE and the at least one third UE, and the at least one second SLPP PDU to the LMF using at least one of correlation IDs, UE IDs and routing IDs.

In another embodiment of the disclosure, the apparatus comprises the at least one first SLPP PDU and the at least one second SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

In another embodiment of the disclosure, an apparatus for obtaining location of a user equipment (UE), the apparatus comprises: one or more memories; and one or more processors coupled to the memories and adapted to: transmit, by the at least one second UE, at least one location service (LCS) request, to a location management function (LMF); receive, by the at least one second UE, at least one first sidelink positioning protocol data units (SLPP PDUs), from the LMF, wherein the at least one first SLPP PDU includes at least one first session ID; segregate, by the at least one second UE, the at least one first SLPP PDU to construct at least one third SLPP PDU; wherein segregating the at least one first SLPP PDU to the at least one third SLPP PDU, further comprises: one of, include, by the at least one second UE, the at least one first session ID, in the at least one third SLPP PDU; and, add, by the at least one second UE, at least one second session ID, in the at least one third SLPP PDU and distribute, by the at least one second UE, the at least one third SLPP PDU, to the at least one third UE, receive, by the at least one second UE, at least one fourth SLPP PDU, from the at least one third UE; combine, by at least one second UE, the at least one fourth SLPP PDU, to construct at least one second SLPP PDU; send, by the at least one second UE, the at least one second SLPP PDU, to the LMF, receive, by the at least one second UE, at least one location estimate of the first UE, from the LMF.

In another embodiment of the disclosure, the apparatus comprises the LCS request is received by at least one second UE from at least one of an application layer of the at least one second UE and any other UE.

In another embodiment of the disclosure, the apparatus comprises: send, by the at least one second UE, the at least one location estimate of the first UE, to one of the application layer of the at least one second UE and any other UE the application layer of the at least one second UE.

In another embodiment of the disclosure, the apparatus comprises the first UE is one of the at least one second UE and any other UE.

In another embodiment of the disclosure, the apparatus comprises the at least one fourth SLPP PDU contains the at least one first session ID, if the at least one third SLPP PDU includes the at least one first session ID.

In another embodiment of the disclosure, the apparatus comprises the at least one fourth SLPP PDU contains the at least one second session ID, if the at least one third SLPP PDU includes the at least one second session ID.

In another embodiment of the disclosure, the apparatus comprises the at least one second SLPP PDU is transmitted to the LMF, through a next generation-radio access network (NG-RAN), followed by an access and mobility management function (AMF).

In another embodiment of the disclosure, the apparatus comprises the AMF handles the routing of the at least one second SLPP PDU to the LMF using at least one of correlation IDs, UE IDs and routing IDs.

In another embodiment of the disclosure, the apparatus comprises the at least one first SLPP PDU, the at least one second SLPP PDU, the at least one third SLPP PDU, and the at least one fourth SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

In another embodiment of the disclosure, an apparatus for side link positioning (SL) and ranging to estimate the location of at least one first user equipment (UE), the apparatus comprises: one or more memories; and one or more processors coupled to the memories and adapted to: receive, by at least one second UE, a ranging and SL positioning service request from at least one of an application layer of the at least one second UE or any other UE, discover, by the at least one second UE, the at least one of at least one first SL anchor UE, at least one first SL positioning server UE, and at least one first SL located UE, select, by the at least one second UE, at least one of the at least one second SL anchor UE from the at least one first SL anchor UE, at least one second SL located UE from the at least one first SL located UE, and a SL positioning server UE from at least one of the at least one first SL positioning server UE and the at least one second UE, forward, by the at least one second UE, the ranging and SL positioning service request to the SL positioning server UE, receive, by the at least one second UE, at least one location estimate of the at least one UE, from the SL positioning server UE, send, by the at least one second UE, the at least one location estimate of the first UE, to at least one of the first UE, any other UE, and the application layer of the at least one second UE.

In another embodiment of the disclosure, the apparatus comprises forwarding of the ranging and SL positioning service request includes a list of at least one of the at least one second SL anchor UE, the at least one second SL located UE, and the at least one second UE.

In another embodiment of the disclosure, the apparatus comprises selecting the SL positioning server UE further configured to: exchange, by the SL positioning server UE, at least one SLPP PDU with the at least one of the at least one second UE, the at least one SL anchor UE and the at least one SL located UE, using the PC5 link to estimate the location of the first UE.

In another embodiment of the disclosure, the apparatus comprises the at least one location of the first UE, is at least one of absolute location, relative location, and ranging information.

In another embodiment of the disclosure, the apparatus comprises the at least one SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

In another embodiment of the disclosure, an apparatus to enable the transmission and reception of sidelink positioning reference signal, the apparatus comprises: one or more memories; and one or more processors coupled to the memories and adapted to perform: one of; receive, by at least one positioning server, at least one request from at least one pair of UEs, transmit, by the at least one positioning server, at least one sequence ID, to the at least one pair of UEs, and, transmit, by the at least one positioning server, at least one request to at least one first UE, receive, by the at least one positioning server, at least one sequence ID, from the at least one first UE, receive, by the at least one positioning server, at least one request from at least one second UE, transmit, by the at least one positioning server, the at least one sequence ID to the at least one second UE.

In another embodiment of the disclosure, the apparatus comprises transmit, by the at least one first UE, at least one sidelink positioning reference signal (SL PRS) using the at least one sequence ID.

In another embodiment of the disclosure, the apparatus comprises receive, by the at least one second UE, the at least one sequence ID, receive, by the at least one second UE, the at least one SL PRS, decode, by the at least one second UE, the at least one SL PRS, using the at least one sequence ID.

In another embodiment of the disclosure, the apparatus comprises the positioning server is at least one of a location management function (LMF) and a SL positioning server UE.

In another embodiment of the disclosure, the apparatus comprises the sequence ID is a value between 0-4095.

In another embodiment of the disclosure, the apparatus comprises the sequence ID is exchanged using the at least one SLPP PDU.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates Sidelink positioning operational scenarios.

FIG. 2 illustrates Sidelink positioning protocol (SLPP) endpoints concept.

FIG. 3 illustrates SLPP PDU configuration for in-coverage scenario, in accordance with an embodiment of present disclosure.

FIG. 4 illustrates procedure for LMF to get UE IDs, in accordance with an embodiment of present disclosure.

FIG. 5 illustrates a method of obtaining location of a first user equipment (UE).

FIG. 6 illustrates SLPP PDU configuration for partial-coverage scenario, in accordance with an embodiment of present disclosure.

FIG. 7 illustrates a method of obtaining location of first user equipment (UE).

FIG. 8 illustrates SLPP PDU alternate configuration for partial-coverage scenario, in accordance with an embodiment of present disclosure.

FIG. 9 illustrates a method for side link positioning (SL) and ranging to estimate the location of a user equipment (UE).

FIG. 10 illustrates a) LMF/positioning server generates and handles Sequence ID and provides Sequence ID to both TX and RX UEs b) LMF/Positioning server distributes Sequence ID taken from TX UE to RX UE, in accordance with an embodiment of present disclosure.

FIG. 11 illustrates SLPP Container ASN.1 implementation, in accordance with an embodiment of present disclosure.

FIG. 12 illustrates a method to enable the transmission and reception of sidelink positioning reference signal.

FIG. 13 illustrates procedure for sidelink positioning and ranging (UE-only operation), in accordance with an embodiment of present disclosure.

### DETAILED DESCRIPTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

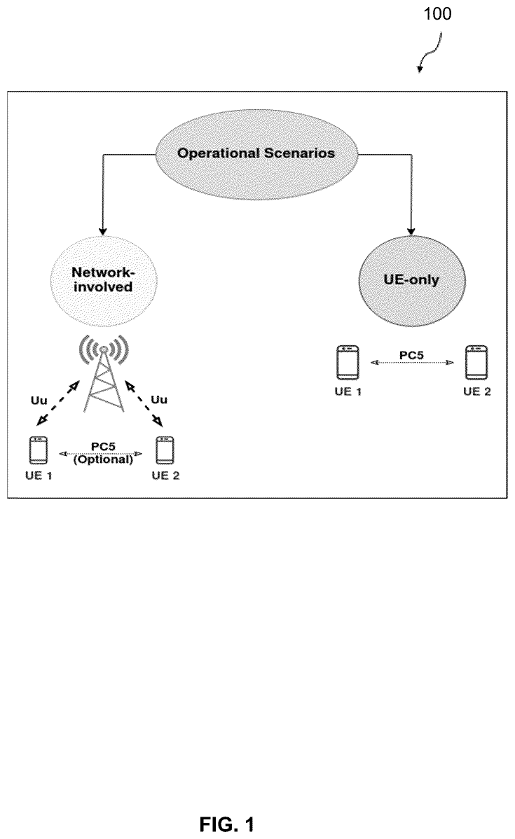

FIG. 1 illustrates the sidelink positioning and ranging operation can be broadly classified into two categories: network-involved and UE-only operation. The network-involved case is where the LMF controls the positioning activity. The LMF communicates with the UE via the Uu link. It may also opt for indirect communication with a set of UEs by enabling the PC5 link with them via one of the UEs with which the LMF has a Uu link connection. The UE-only operation is where there is no network connectivity and the UEs involved in the positioning activity should be coordinated by a positioning server UE which may be the target/anchor/3rd party UE. The present disclosure primarily focuses on the network-involved scenarios for the sidelink positioning protocol (SLPP) PDU configurations.

The LMF packs the SLPP PDU for the LMF to UE communication and sends it over to the access and mobility management function (AMF). In LTE positioning protocol (LPP), the LMF always has a one-to-one connection with the UE. But this need not be the case in SLPP. For UEs that do not have the network connection directly but may access the network via a PC5 link with another UE in the network, LMF doesn't have a one-to-one connection. In this scenario, LMF may communicate with the out-of-coverage (OOC) UEs via the anchor UE which is in-coverage (IC) as well as can reach the out-of-coverage using the PC5 link. Furthermore, even if all the UEs are connected to the network, the LMF can still choose to communicate with a set of UEs via some anchor UE in-coverage, which can establish sidelink communication with that set of UEs. The present disclosure covers both cases.

For positioning measurements over PC-5 in sidelink, sidelink positioning reference signal (SL-PRS) will be transmitted from one or more anchor UE to the desired target UE or vis-à-vis. For the generation of SL-PRS, a pseudo-random sequence is used which depends on the parameter sequence-ID to initialize the seed value. This parameter can be configured to the physical layer either as a higher layer parameter or as the last 12 least significant bits (LSB) of the physical sidelink control channel (PSCCH) cyclic redundancy check (CRC). This higher layer can be inside sidelink positioning and ranging layer, sidelink positioning server, location management function (LMF) or sidelink application layer. The present disclosure focuses on the scenario where the sequence-ID is configured via the LMF in the network-involved case and by the positioning server in the UE-only operation.

The abstract syntax notation dot 1 (ASN.1) encoding is used for the SLPP messages, and it can be handled in multiple ways. Some possibilities include a separate SLPP signaling between UE(s) and LMF or enhancing the existing LPP message where the SLPP PDU is carried as a container inside the LPP message body transparently. The present disclosure provides a process on the latter case. The SLPP PDU configuration discussed in this document is independent of the ASN.1 encoding format used.

The final section covered in the present disclosure is related to the signaling between UEs involved in a UE-only sidelink positioning operation. Similar to the LMF, in the case of network-involved SL positioning, the SL positioning server manages the positioning activity for the UE-only operation. The SL positioning server can be the target/anchor/a 3rd party UE. It should have the capabilities to manage the sidelink positioning session, coordinate with the participating UEs, do location estimation, and so on. The present disclosure focuses on the message exchanges between server UE and other UEs for a PC5-only scenario.

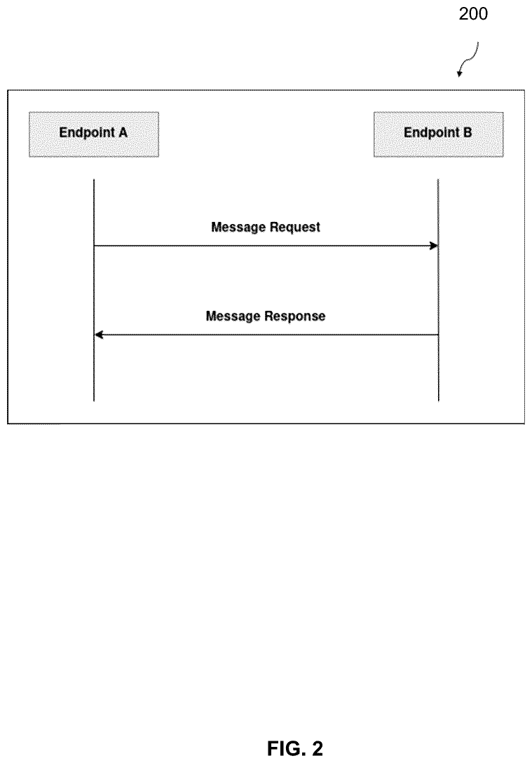

FIG. 2 illustrates that each SLPP transaction involves the exchange of one or more SLPP messages between Endpoint A and Endpoint B. This endpoint can be one of the anchor UE, reference UE, target UE, located UE, and positioning reference unit (PRU). The general format of an SLPP message consists of a set of common fields followed by a body. The body (which may be empty) contains information specific to a particular positioning message type. Each message type contains information specific to one or more positioning methods and/or information common to all positioning methods.

In an embodiment of the disclosure, the common fields are discussed as the following:

| Field | Description |
|---|---|
| sessionID | Identify messages belonging to the same session |
| transactionID | Identify messages belonging to the same transaction |
| endTransaction | Indicate when a transaction (e.g. one |
| | with periodic responses) has ended |
| sequenceNumber | Enable detection of a duplicate SLPP |
| | message at a receiver |
| acknowledgement | Enable an acknowledgement to be requested |
| | and/or returned for any SLPP message |

In another embodiment of the disclosure, the following message types are defined:
Request Capabilities
Provide Capabilities
Request Assistance Data
Provide Assistance Data
Request Location Information
Provide Location Information
Abort
Error

In an embodiment of the disclosure, a method to form SLPP PDU and distributing it across multiple UEs is discussed for both in-coverage and partial-coverage (PC) scenarios.

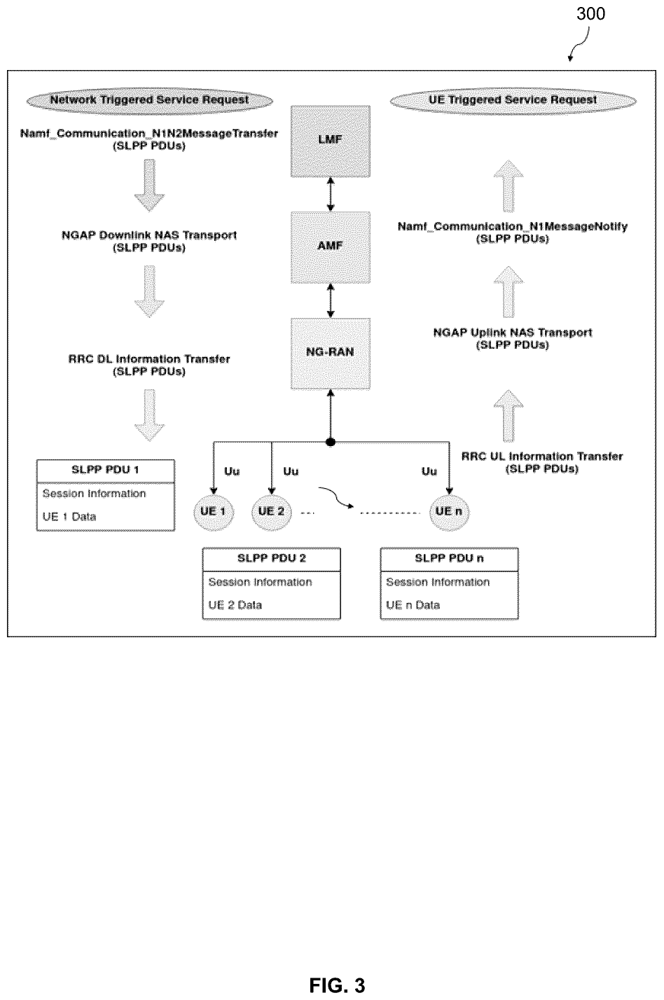

FIG. 3 illustrates an embodiment of the disclosure for in-coverage scenario, in which let us consider the case where all the UEs are connected to the network. We assume that all the UEs are involved with the same positioning session and are served by the same LMF.

Here, the LMF can directly communicate with all the UEs using the Uu link. In the case of both network-triggered service requests as well as UE-triggered service requests, the SLPP PDUs for each of the UEs are first generated at the LMF end. The subsequent PDUs can be formed at the UE end and/or LMF end based on the message type. Each of the UEs shall be informed of the session information in the SLPP PDU along with the corresponding data for the UE. The SLPP PDUs are packed inside Namf_Communication_N1N2MessageTransfer messages by the LMF and sent to the AMF. At the AMF, these are forwarded to the next generation radio access network (NG-RAN) in the form of NGAP Downlink NAS Transport messages. The NG-RAN distributes the corresponding PDUs to each of the UEs as RRC DL Information Transfer messages. The routing to the individual UEs shall be done using correlation IDs/UE IDs and routing IDs which are handled at the AMF.

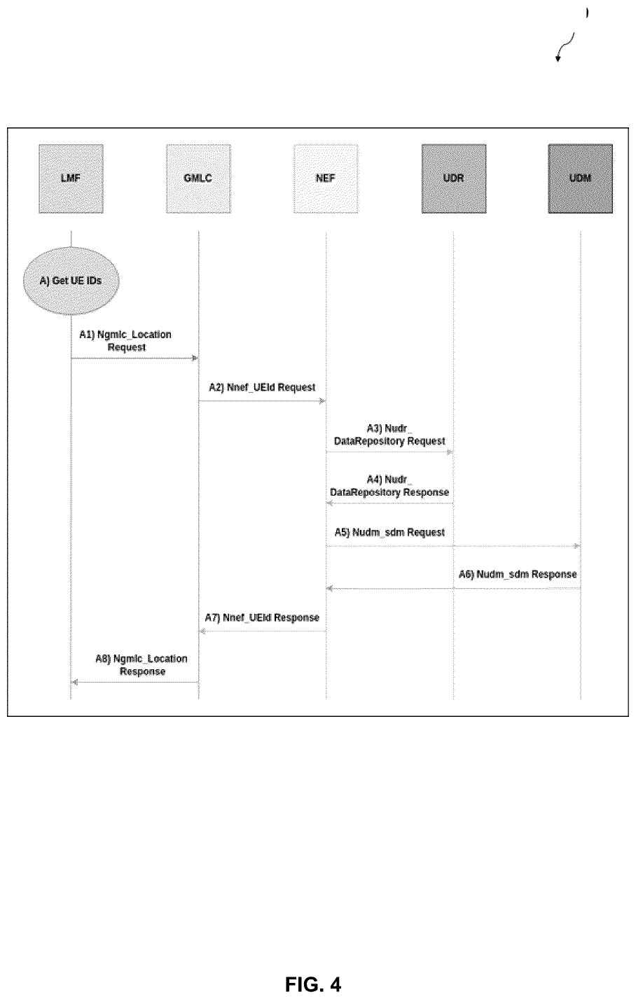

FIG. 4 illustrates yet another embodiment of the disclosure in which the LMF obtains the list of UE IDs and provides it to the AMF. The AMF may use the corresponding correlation IDs for every UE IDs or directly the UE IDs to communicate with the entire list of UEs involved with the positioning activity. The LMF generates the data for each of the UEs and sends it to the AMF with its correlation ID/UE ID assigned. The AMF maps the correlation IDs/UE IDs received from the LMF to the corresponding NAS routing IDs of the UE which is then used to forward the data from the LMF to each of the UE 1/ . . . /n. The individual UE data may consist of fields such as transactionID, endTransaction, sequenceNumber, acknowledgment, and any of the message types applicable.

If the service request is UE-triggered, some changes are applicable compared to the network-triggered service request. The target UE is expected to send the location service (LCS) request to the LMF. The LMF can either trigger a discovery procedure by the target UE to find the reference UEs or it may use any prior information regarding the reference UEs if available at the AMF/GMLC end. The correlation (or UE)/routing IDs shall be decided accordingly at AMF. The session information is given to all the UEs by the LMF in the initial SLPP PDUs. The SLPP PDUs generated at the UE are delivered to the NG-RAN as RRC UL Information Transfer messages using the routing ID. The NG-RAN forwards the PDUs to the AMF inside NGAP Uplink NAS Transport messages. The AMF packs the SLPP PDUs based on the mapping of the correlation (or UE)/routing IDs and sends them to the LMF as Namf_Communication_N1MessageNotify messages. The LMF processes the individual UE data as per the corresponding correlation IDs/UE IDs.

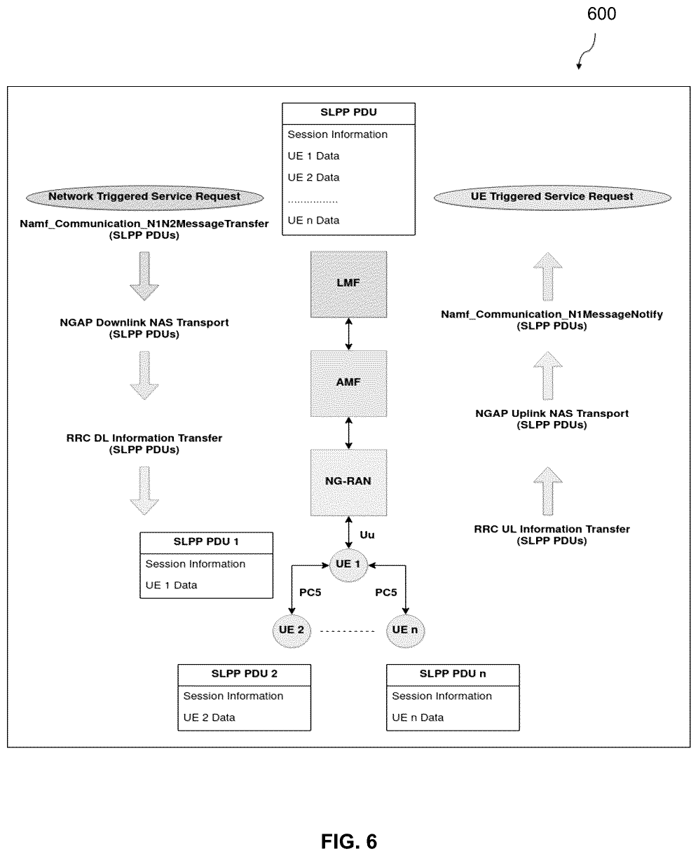

There could be an alternative scenario where even if all the UEs are in the network, the LMF may opt to serve just one of the UEs, and that UE shall establish a PC5 link with the rest of the UEs. The handling of such an operation is similar to the partial-coverage scenario which will be discussed in FIG. 6.

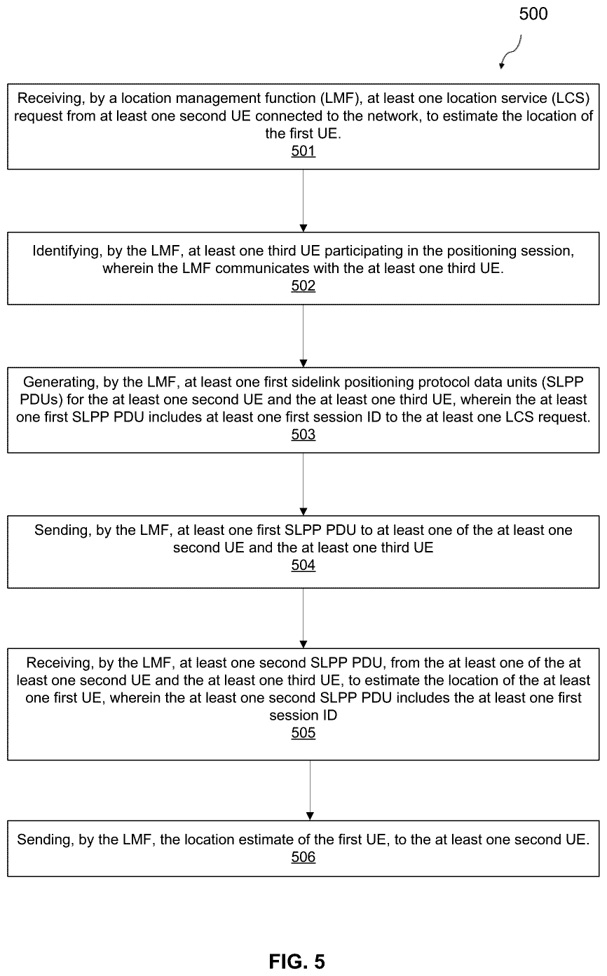

FIG. 5 illustrates a method of obtaining location of a first user equipment (UE) in accordance with an embodiment of the disclosure, the method (500) involves the following steps: at step 501, receiving, by a location management function (LMF), at least one location service (LCS) request from at least one second UE connected to the network, to estimate the location of the first UE. At step 502, identifying, by the LMF, at least one third UE participating in the positioning session, wherein the LMF communicates with the at least one third UE. At step 503, generating, by the LMF, at least one first sidelink positioning protocol data units (SLPP PDUs) for the at least one second UE and the at least one third UE, wherein the at least one first SLPP PDU includes at least one first session ID to the at least one LCS request. At step 504, sending, by the LMF, at least one first SLPP PDU to at least one of the at least one second UE and the at least one third UE. At step 506, receiving, by the LMF, at least one second SLPP PDU, from the at least one of the at least one second UE and the at least one third UE, to estimate the location of the at least one first UE, wherein the at least one second SLPP PDU includes the at least one first session ID. At step 507, sending, by the LMF, the location estimate of the first UE, to the at least one second UE.

In another embodiment of the disclosure, the method comprises first UE is one of the at least one second UE, and any other UE.

In another embodiment of the disclosure, the method comprises the LCS request is received by at least one second UE from at least one of an application layer of the at least one second UE and any other UE.

In another embodiment of the disclosure, the method comprises the LMF communicates with the at least one third UE is by using one of, the Uu link; and, the at least one second UE, via the PC5 link.

In another embodiment of the disclosure, the method comprises the at least one first SLPP PDU is transmitted to the at least one of the at least one second UE and the at least one third UE, through an access and mobility management function (AMF), followed by a next generation-radio access network (NG-RAN).

In another embodiment of the disclosure, the method comprises receiving, by the LMF, the at least one second SLPP PDU, from the at least one of the at least one second UE and the at least one third UE, from the NG-RAN, through the AMF.

In another embodiment of the disclosure, the method comprises wherein the AMF handles the routing of the at least one first SLPP PDU to at least one of the at least one second UE and the at least one third UE, and the at least one second SLPP PDU to the LMF using at least one of correlation IDs, UE IDs and routing IDs.

In another embodiment of the disclosure, the method comprises the at least one first SLPP PDU and the at least one second SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

FIG. 6 illustrates yet another embodiment of the disclosure, in which only some of the UEs are connected to the network and the remaining UEs are out-of-coverage, where only one UE is assumed to be connected to the network.

As mentioned earlier, the procedure that is discussed FIG. 6 applies to the in-coverage cases as well when the PC5 link is used. It is considered that all the UEs are involved with the same positioning session. Here, the LMF doesn't communicate with all the UEs. Instead, it picks one of the UEs, say UE 1, which is capable of establishing a sidelink communication with the remaining UEs 2/ . . . /n. It is considered that UE 1 is capable of acting as the positioning server. UE 1 is responsible for discovering the other UEs. The information about UE 2/ . . . /n is shared with the LMF via AMF by UE 1. In the case of both network-triggered service requests as well as UE-triggered service requests, the SLPP PDUs for each of the UEs are first generated at the LMF end. The subsequent PDUs can be formed at the UE end and/or LMF end based on the message type.

The LMF generates the data for each of the UEs including UE 1 and packs them together in one or more PDUs depending on the payload size and sends it to UE 1 via AMF using the correlation/routing ID of UE 1. The session information is included in the PDUs. The SLPP PDUs are packed inside Namf_Communication_N1N2Message-Transfer messages by the LMF and sent to the AMF. At the AMF, these are forwarded to the NG-RAN in the form of NGAP Downlink NAS Transport messages. The NG-RAN distributes the corresponding PDUs to each of the UEs as RRC DL Information Transfer messages. Similar to the in-coverage scenario, the routing to the individual UEs shall be done using correlation IDs/UE IDs and routing IDs which are handled at the AMF. The LMF obtains the list of UE IDs as shown in FIG. 4 and provides it to the AMF.

In yet another embodiment of the disclosure, UE 1 is responsible for distributing the PDUs to the other UEs. The PDUs are packed such that UE 1 on reception can identify the data meant for itself as well as other individual UE data. UE 1 may extract its data if available and then pack individual UE data into separate PDUs with the original session information received from the LMF intact.

If the service request is UE-triggered, similar to that of in-coverage scenario, some changes are applicable compared to the network-triggered service request. The target UE must be in-coverage, and in this case, it is UE 1. The target UE is expected to send the location service (LCS) request to the LMF. The LMF triggers a discovery procedure by the target UE to find the reference UE. UE 1 reports back with the list of discovered UEs, in this case, UE 2/ . . . /n. The LMF obtains the list of UE IDs as shown in FIG. 4 and provides it to the AMF. The AMF may use the corresponding correlation IDs for every UE IDs or directly the UE IDs to communicate with the LMF data corresponding to each of the UEs. To distinguish from the in-coverage scenario, the LMF shall communicate with UE 2/ . . . /n indirectly using the PC5 link of UE 1. The session information is given to UE 1 by the LMF in the initial SLPP PDUs. The SLPP PDUs generated at the UEs end are delivered to the NG-RAN as RRC UL Information Transfer messages using the routing IDs. The NG-RAN forwards the PDUs to the AMF inside NGAP Uplink NAS Transport messages. The AMF packs the SLPP PDUs based on the mapping of the correlation and routing ID and sends them to the LMF as Namf_Communication_N1MessageNotify messages. The LMF processes the individual UE data as per the corresponding correlation IDs/UE IDs.

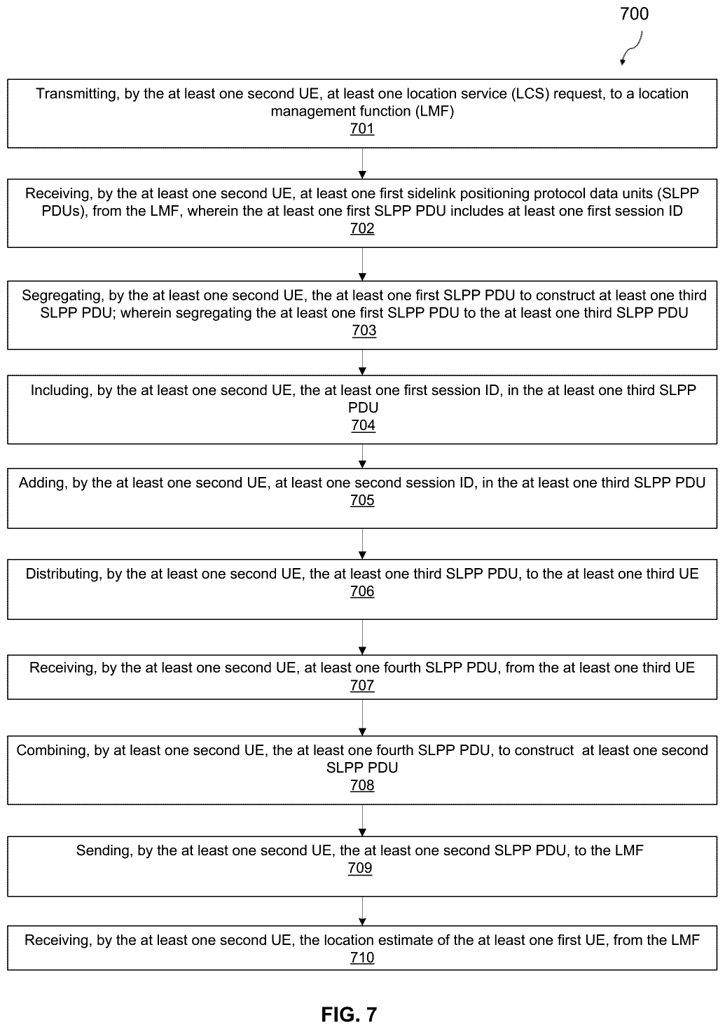

FIG. 7 illustrates a method of obtaining location of first user equipment (UE) in accordance with an embodiment of the disclosure, the method (700) involves the following steps: At step 701 transmitting, by the at least one second UE, at least one location service (LCS) request, to a location management function (LMF). At step 702, receiving, by the at least one second UE, at least one first sidelink positioning protocol data units (SLPP PDUs), from the LMF, wherein the at least one first SLPP PDU includes at least one first session ID. At step 703, segregating, by the at least one second UE, the at least one first SLPP PDU to construct at least one third SLPP PDU; wherein segregating the at least one first SLPP PDU to the at least one third SLPP PDU, further comprises: one of, at 704, including, by the at least one second UE, the at least one first session ID, in the at least one third SLPP PDU and, at step 705, adding, by the at least one second UE, at least one second session ID, in the at least one third SLPP PDU. At step 706, distributing, by the at least one second UE, the at least one third SLPP PDU, to the at least one third UE. At step 707, receiving, by the at least one second UE, at least one fourth SLPP PDU, from the at least one third UE. At step 708, combining, by at least one second UE, the at least one fourth SLPP PDU, to construct at least one second SLPP PDU. At step 709, sending, by the at least one second UE, the at least one second SLPP PDU, to the LMF. At step 710, receiving, by the at least one second UE, the location estimate of the at least one first UE, from the LMF.

In another embodiment of the disclosure, the method comprises the LCS request is received by at least one second UE from one of an application layer of the at least one second UE or any other UE.

In another embodiment of the disclosure, the method comprises: sending, by the at least one second UE, the location estimate of the first UE, to one of the application layer of the at least one second UE or any other UE.

In another embodiment of the disclosure, the method comprises the first UE is one of the at least one second UE, or any other UE.

In another embodiment of the disclosure, the method comprises the at least one fourth SLPP PDU contains the at least one first session ID, if the at least one third SLPP PDU includes the at least one first session ID.

In another embodiment of the disclosure, the method comprises the at least one fourth SLPP PDU contains the at least one second session ID, if the at least one third SLPP PDU includes the at least one second session ID.

In another embodiment of the disclosure, the method comprises the at least one second SLPP PDU is transmitted to the LMF, through a next generation-radio access network (NG-RAN), followed by an access and mobility management function (AMF).

In another embodiment of the disclosure, the method comprises the AMF handles the routing of the at least one second SLPP PDU to the LMF using at least one of correlation IDs, UE IDs and routing IDs.

In another embodiment of the disclosure, the method comprises the at least one first SLPP PDU, the at least one second SLPP PDU, the at least one third SLPP PDU, and the at least one fourth SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

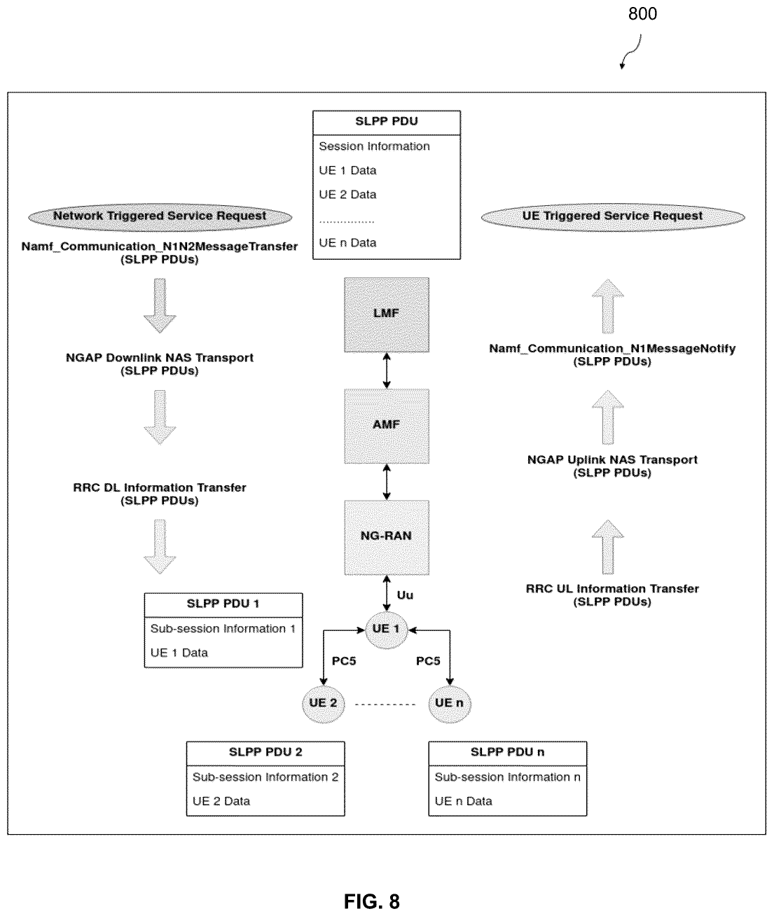

FIG. 8 illustrates an alternate embodiment of the disclosure, in which UE 1 can initiate sub-sessions for its data if available as well as for UE 2/ . . . /n instead of relying on the original session information received from the LMF. Here UE 1 is solely responsible for maintaining the sub-sessions for UE 2/ . . . /n and synchronizing with the original session initiated by the LMF. The remaining procedures shall remain the same as discussed above.

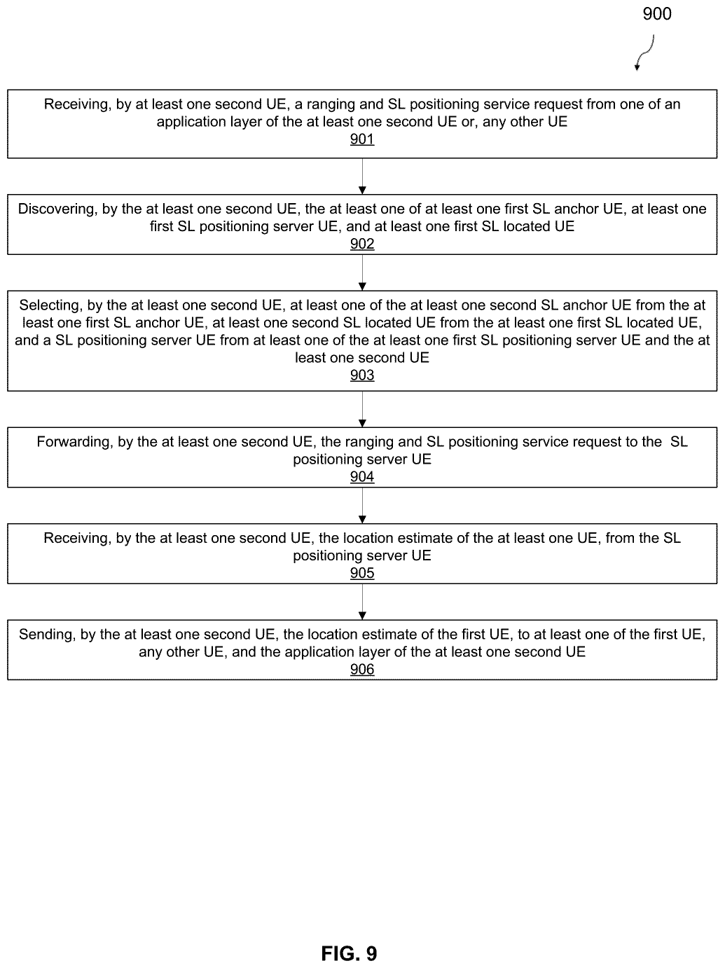

FIG. 9 illustrates a method for side link positioning (SL) and ranging to estimate the location of a user equipment (UE), in accordance with an embodiment of the disclosure, the method (900) involves the following steps: At step 901, receiving, by at least one second UE, a ranging and SL positioning service request from one of an application layer of the at least one second UE or any other UE. At step 902, discovering, by the at least one second UE, the at least one of at least one first SL anchor UE, at least one first SL positioning server UE, and at least one first SL located UE. At step 903, selecting, by the at least one second UE, at least one of the at least one second SL anchor UE from the at least one first SL anchor UE, at least one second SL located UE from the at least one first SL located UE, and a SL positioning server UE from at least one of the at least one first SL positioning server UE and the at least one second UE. At step 904, forwarding, by the at least one second UE, the ranging and SL positioning service request to the SL positioning server UE. At step 905, receiving, by the at least one second UE, the location estimate of the at least one UE, from the SL positioning server UE. At step 906, sending, by the at least one second UE, the location estimate of the first UE, to at least one of the first UE, any other UE, and the application layer of the at least one second UE.

In another embodiment of the disclosure, the method comprises the forwarding of the ranging and SL positioning service request includes a list of at least one of the at least one second SL anchor UE, the at least one second SL located UE, and the at least one second UE.

In another embodiment of the disclosure, the method comprises selecting the SL positioning server UE further comprises: exchanging, by the SL positioning server UE, at least one SLPP PDU with the at least one of the at least one second UE, the at least one SL anchor UE and the at least one SL located UE, using the PC5 link to estimate the location of the first UE.

In another embodiment of the disclosure, the method comprises the at least one location estimate of the first UE, is at least one of absolute location, relative location, and ranging information.

In another embodiment of the disclosure, the method comprises the at least one SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

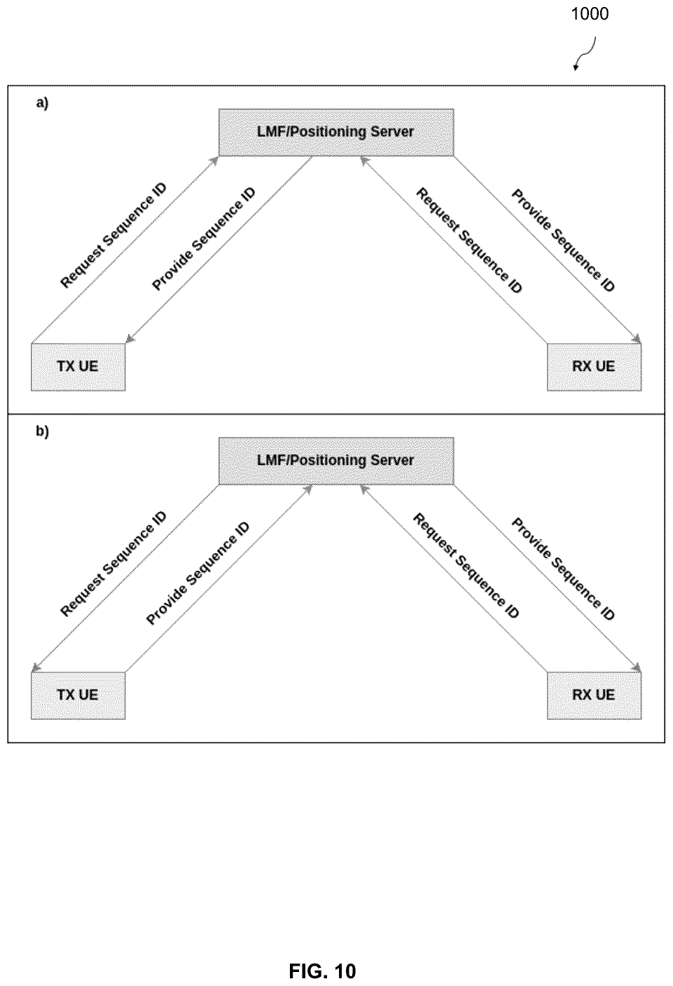

In yet another embodiment of the disclosure, FIG. 10 illustrates that the sequence-ID parameter is one of the most critical configurations that determine the uniqueness of the SL-PRS transmission for a UE. The method by which this parameter is configured for all the UEs involved in the same positioning session or different positioning session can affect the efficiency of resource utilization, and proper scheduling as well as minimizing the collision among multiple UEs participating in positioning activities. This document discusses the SL-PRS sequence-ID parameter configurations for both network-involved and UE-only scenarios.

For in-coverage scenarios, the LMF shall be responsible for generating the sequence-IDs as per the requirements. The LMF shall select the values appropriately for each of the UEs and include them in the corresponding UE data as part of the assistance information. There may also be cases where LMF need not provide sequence-ID values. In such situations, the UEs can themselves select from the decimal representation of the CRC for the sidelink control information mapped to the PSCCH associated with the SL-PRS. The LMF shall make sure that the same sequence-ID values are configured for a particular pair of transmitting and receiving UEs, and different pairs shall be configured with different sequence-ID values.

The same procedure shall be applied for the partial-coverage scenarios also with the difference that the LMF configures the sequence-ID values for the out-of-coverage UEs via a UE which is in-coverage. In the case of out-of-coverage scenario, similar to the LMF in the IC and PC cases, the positioning server UE shall be responsible for generating the sequence-IDs as per the requirements. This document proposes some methods by which the sequence-ID generation can be handled by the LMF/server UE.

The sequence-ID can take values from 0 to 4095. The primary objective is to assign unique sequence-ID value to every transmit (TX) and receive (RX) UE pair. The sequence-ID value can be conveyed via the assistance information messages. There are two possibilities. The UE shall request assistance information from the LMF/server and the LMF/server shall provide the corresponding sequence-ID. In the second case, the LMF/server shall request assistance information from the UE (mainly from TX) and the UE responds with the assistance information containing one or more possible SL-PRS resource configurations. LMF/server will select the SL-PRS configuration and assign corresponding sequence-ID which will be provided as SLPP message to the TX and RX UE.

Furthermore, each TX-RX pair may need to be configured with multiple sequence-ID values if multiple SL-PRS resources are configured. This is determined by the number of antenna beams supported by the TX/RX UE. This shall be conveyed to the LMF/server by the UE during the assistance information request/response. In general, if there are n number of UEs active in a positioning session, with lᵢ number of antenna beams active for the i^{th} TX-RX UE pair, the total number of unique sequence-ID values to be generated by the LMF/server UE is Σᵢ₌₁ⁿ⁻¹lᵢ. If the antenna beam information is not available at the LMF/server, it shall configure a default value to the corresponding TX-RX UE pair.

FIG. 10 illustrates the SLPP procedure for obtaining the sequence-ID parameter. The node which requires the sequence-ID requests for assistance data using the SLPP PDU and the node which is responsible for handling the sequence-ID provides the parameter using provide assistance data SLPP PDU. There are two possibilities by which the sequence-ID parameter can be conveyed within a TX-RX pair as illustrated in FIG. 10 a) and b).

In the a) part, the LMF (for in-coverage and partial coverage) or the positioning server (for out-of-coverage) is responsible for generating and handling the sequence-ID. The TX and RX UEs request to the LMF for the sequence-ID to which the LMF provides the sequence-ID to both the UEs according to embodiment illustrated in FIG. 2. In the b) part, the LMF or the positioning server merely acts as a distributing medium where the LMF/server requests for sequence-ID from the TX UE and once obtained as per FIG. 2 procedure, forwards the same to the RX UE that already put a request message to the LMF for sequence-ID.

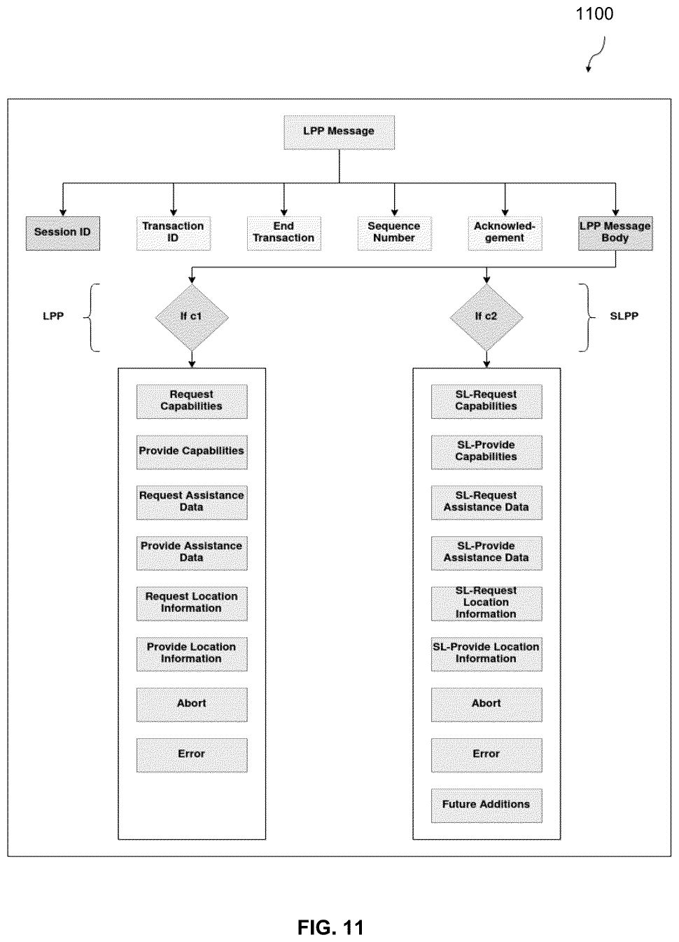

In yet another embodiment of the disclosure as illustrated in FIG. 11 the existing LPP message IE consists of fields such as transaction ID, end transaction, sequence number, acknowledgment, and LPP message body. This ASN.1 structure doesn't allow additional fields at this level. Hence, new fields can be added inside the LPP message body. The current LPP message body consists of a single choice field c1 which comprises a further choice of LPP functional attributes such as request capabilities, provide capabilities, etc.

LPP-Message
-- ASN1START
LPP-Message ::= SEQUENCE {

| transactionID | LPP-TransactionID | OPTIONAL, -- Need ON |
|---|---|---|
| endTransaction | BOOLEAN; | |
| sequenceNumber | SequenceNumber | OPTIONAL, -- Need ON |
| acknowledgement | Acknowledgement | OPTIONAL, -- Need ON |
| lpp-MessageBody | LPP-MessageBody | OPTIONAL, -- Need ON |

}
-- ASN1STOP
LPP-MessageBody
-- ASN1START
LPP-MessageBody ::= CHOICE {

| | |
|---|---|
| c1 | CHOICE { |
| requestCapabilities | RequestCapabilities, |
| provideCapabilities | ProvideCapabilities, |
| requestAssistanceData | RequestAssistanceData, |
| provideAssistanceData | ProvideAssistanceData, |
| requestLocationInformation | RequestLocationInformation, |
| provideLocationInformation | ProvideLocationInformation, |
| abort | Abort, |
| error | Error, |

```
    spare7 NULL, spare6 NULL, spare5 NULL, spare4 NULL,
    spare3 NULL, spare2 NULL, spare1 NULL ,spare0 NULL
  },
```

| | |
|---|---|
| messageclassExtension | SEQUENCE { } |

}
-- ASN1STOP

In yet another embodiment of the disclosure, to add a new choice c2 which comprises a further choice of SLPP functional attributes such as SL-request capabilities, SL-provide capabilities, etc., and with an option to extend in future versions. This approach has the advantage of retaining the existing LPP protocol between the UE and the LMF. Here, for LPP-only applications choice c1 is enabled while for network-assisted sidelink applications, choice c2 is used.

LPP-MessageBody

-- ASN1START
LPP-MessageBody ::= CHOICE {

| | |
|---|---|
| c1 | CHOICE { |
| requestCapabilities | RequestCapabilities, |
| provideCapabilities | ProvideCapabilities, |
| requestAssistanceData | RequestAssistanceData, |
| provideAssistanceData | ProvideAssistanceData, |
| requestLocationInformation | RequestLocationInformation, |
| provideLocationInformation | ProvideLocationInformation, |
| abort | Abort, |
| error | Error, |

```
    spare7 NULL, spare6 NULL, spare5 NULL spare4 NULL,
    spare3 NULL, spare2 NULL, spare1 NULL, spare0 NULL
  },
```

| | |
|---|---|
| later | CHOICE { |
| c2 | CHOICE { |
| sl-requestcapabilities | RequestCapabilities, (OCTET STRING) |
| sl-provideCapabilities | ProvideCapabilities, |
| sl-requestAssistanceData | RequestAssistanceData, |
| sl-provideAssistanceData | ProvideAssistanceData, |
| sl-requestLocationinformation | RequestLocationinformation, |
| sl-provideLocationInformation | ProvideLocationInformation, |
| sl-abort | Abort, |
| sl-error | Error, |

```
      spare7 NULL, spare6 NULL, spare5 NULL, spare4 NULL,
      spare3 NULL, spare2 NULL, spare1 NULL, spare0 NULL
    },
```

| | |
|---|---|
| messageClassExtension | SEQUENCE { } |

}
}
-- ASN1STOP

In yet another embodiment of the disclosure, FIG. 11 illustrates ASN.1 format for the SLPP message container method introduces an additional option c2 as part of the message extension. Option c2 provides a choice of all the SLPP message types with a scope for future extensions. FIG. 11 depicts the SLPP container approach in a block diagram manner. The common fields applicable for both LPP and SLPP messages are transactionID, endTransaction, sequenceNumber, and acknowledgment. The sessionID parameter is applicable only for SLPP messages and is therefore an optional field. But for network-based operation, explicit sessionID is not required similar to the LPP case, as the sessions can be uniquely identified by the list of correlation/routing IDs maintained at the AMF end. However, the sessionID field is kept in the message structure to maintain uniformity with the UE-only operation scenario where explicit session identification is required. Further the c2 message can be formulated based on the positioning method for which the sidelink positioning and ranging is configured. Possible methods are SL-round trip time (RTT), SL-time difference of arrival (SL-TDOA), SL-time of arrival (SL-TOA), SL-AoA, SL-AoD and SL-carrier phase/phase difference method. For multiple UEs, if the message is packed in the same LPP PDU then based on positioning method, the individual positioning message octet is formulated and concatenated along with UE ID as c2-1, c2-2 up to c2-n if n UEs are configured.

As mentioned in last section, this LPP PDU can be received by one of the UEs say UE 1 in partial coverage case, which is acting as reply node for other UEs say UE 2 to UE n. In this case, UE 1 will receive this LPP PDU and decode the higher LPP message to get the UE IDs. If the UE IDs are corresponding to the other UEs, UE 1 will forward the message as SLPP PDU consisting of the received corresponding octet of the UEs over the PC5 connection.

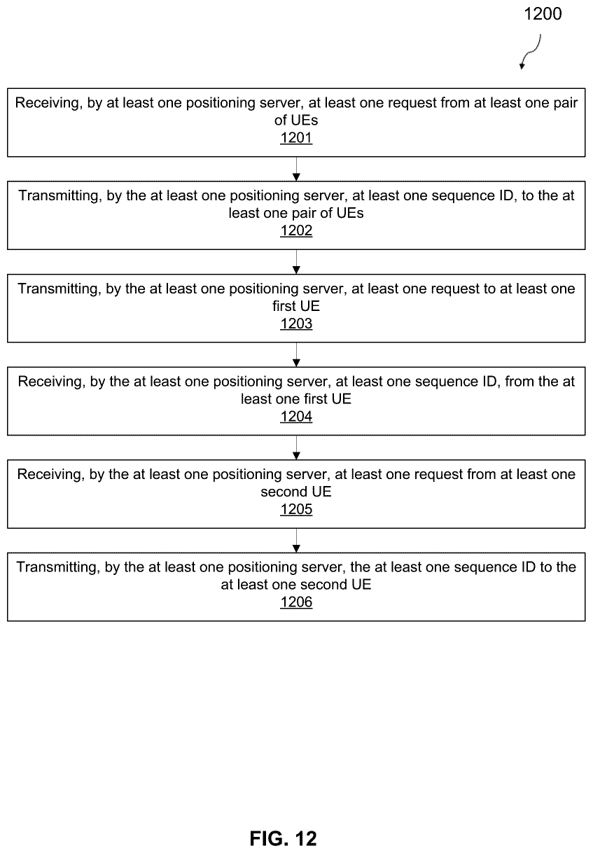

In yet another embodiment of the disclosure FIG. 12 illustrates a method to enable the transmission and reception of sidelink positioning reference signal, the method (1200) involves the following steps: one of; At step 1201, receiving, by at least one positioning server, at least one request from at least one pair of UEs. At step 1202, transmitting, by the at least one positioning server, at least one sequence ID, to the at least one pair of UEs. At step 1203, transmitting, by the at least one positioning server, at least one request to at least one first UE; At step 1204, receiving, by the at least one positioning server, at least one sequence ID, from the at least one first UE. AT step 1205, receiving, by the at least one positioning server, at least one request from at least one second UE. At step 1206, transmitting, by the at least one positioning server, the at least one sequence ID to the at least one second UE.

In another embodiment of the disclosure, the method comprises transmitting, by the at least one first UE, at least one sidelink positioning reference signal (SL PRS) using the at least one sequence ID.

In another embodiment of the disclosure, the method comprises receiving, by the at least one second UE, the at least one sequence ID, receiving, by the at least one second UE, the at least one SL PRS, decoding, by the at least one second UE, the at least one SL PRS, using the at least one sequence ID.

In another embodiment of the disclosure, the method comprises the positioning server is at least one of a location management function (LMF) and a SL positioning server UE.

In another embodiment of the disclosure, the method comprises the sequence ID is a value between 0-4095.

In another embodiment of the disclosure, the method comprises the sequence ID is exchanged using the at least one SLPP PDU.

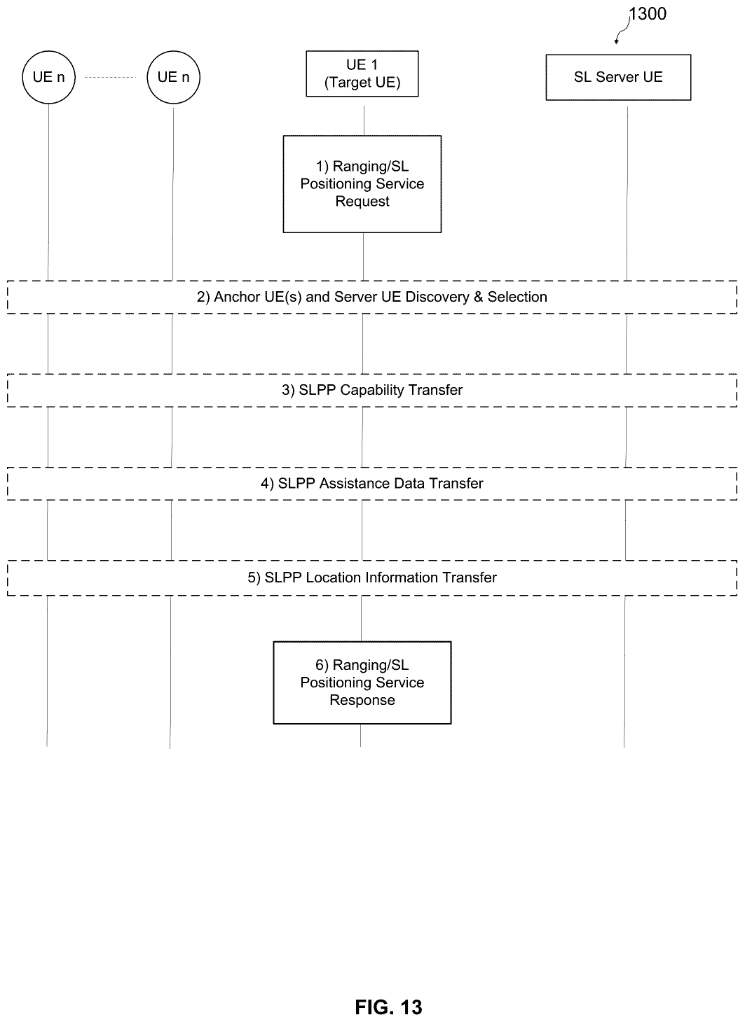

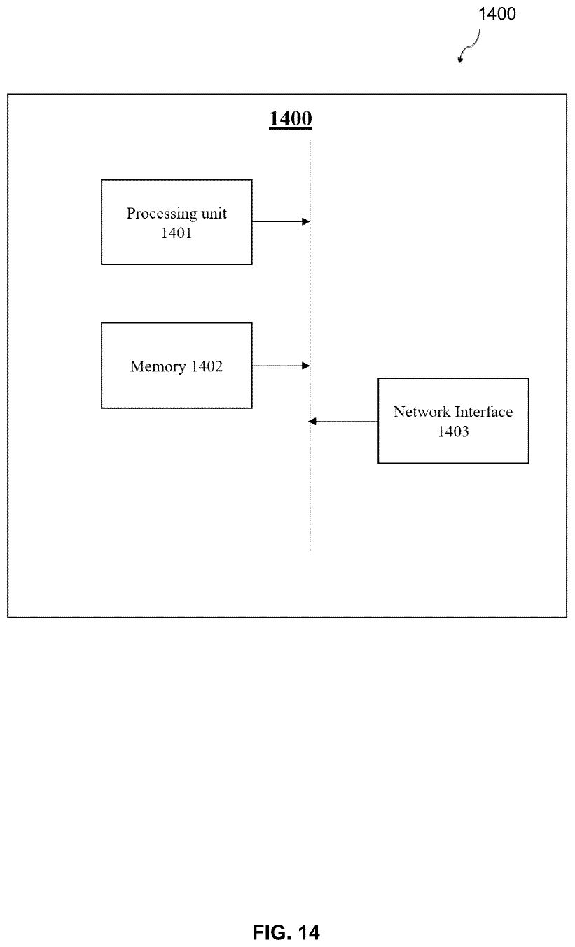

In yet another embodiment of the disclosure, FIG. 13 illustrates the sequence of operation for sidelink positioning and ranging in the UE-only mode of operation as further defined in TS 23.586. 1) UE 1 (i.e., target UE) may receive a Ranging/SL Positioning Service Request from a client UE or from its own application layer as defined in TS 23.586. 2) UE 1 discovers UEs 2 to n, as described in TS 23.586, if not already discovered. Following this discovery, UE 1 shall perform anchor UE and/or SL server UE selection based on the discovery message field contents. If UE 1 has the positioning server capability, the server UE selection can be skipped. The discovery field shall indicate the UE roles for anchor and server UE capabilities. 3) If UE 1 supports the server UE functionality, UE 1 may obtain the sidelink positioning capabilities from UEs 2 to n using the SLPP Capability Transfer procedure described in clause 7.11.2.1 of TS 38.305. If UE 1 does not support the server UE functionality, SL server UE may obtain the sidelink positioning capabilities from UEs 2 to n using the SLPP Capability Transfer procedure described in clause 7.11.2.1 of TS 38.305. 4) If UE 1 supports the server UE functionality, UE1 will provide assistance data to UEs 2 to n using the SLPP Assistance Data Transfer procedure described in clause 7.11.2.2 of TS 38.305. If UE 1 does not support the server UE functionality, SL server UE will provide assistance data to UEs 2 to n using the SLPP Assistance Data Transfer procedure described in clause 7.11.2.2 of TS 38.305. 5) If UE 1 supports the server UE functionality, UE1 will send a request for sidelink location information to UEs 2 to n using the SLPP Location Information Transfer procedure described in clause 7.11.2.3 of TS 38.305. If UE 1 does not support the server UE functionality, SL server UE may send a request for sidelink location information to UEs 2 to n using the SLPP Location Information Transfer procedure described in clause 7.11.2.3 of TS 38.305. 6) The ranging/positioning result is delivered to the requestor from step 1.

FIG. 14 illustrates a general block diagram of the transmitter/receiver, according to an embodiment of the present disclosure. In an embodiment, the transmitter/receiver 1400 may be the plurality of devices, user equipment, base stations, network entities, and the like.

In an example, the transmitter/receiver 1400 includes a processor(s) that may be a single processing unit or a number of units, all of which could include multiple computing units. The processing unit 1401 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processing unit 1401 is configured to fetch and execute computer-readable instructions and data stored in the memory 1402.

The memory 1402 may include any non-transitory computer-readable medium known in the art including, for example, volatile memory, such as static random-access memory (SRAM) and dynamic random access memory (DRAM), and/or non-volatile memory, such as read-only memory (ROM), erasable programmable ROM, flash memories, hard disks, optical disks, and magnetic tapes.

As a further example, the processing unit 1401 coupled with memory may be configured to implement the method as explained in FIGS. 5, 7, 9 and 12. The hardware may include a hardware disk controller with programmable search capabilities or a software system running on general-purpose hardware. Examples of databases but are not limited to, in-memory databases, cloud databases, distributed databases, embedded databases, and the like. The database amongst other things, serves as a repository for storing data processed, received, and generated by one or more of the processor(s).

As a further example, the network interface 1403 is configured to provide and establish communication with any electronic device via a public network, private network, or any wireless communication technology.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular ordershown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a scripting language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise. In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

What we claim:

1. A method of obtaining location of a first user equipment (UE) wherein the method comprising:
receiving, by a location management function (LMF), at least one location service (LCS) request from at least one second UE connected to a network, to estimate the location of the first UE;
identifying, by the LMF, at least one third UE participating in a positioning session, wherein the LMF communicates with the at least one third UE;
generating, by the LMF, at least one first sidelink positioning protocol data units (SLPP PDUs) for the at least one second UE and the at least one third UE, wherein the at least one first SLPP PDU includes at least one first session ID to the at least one LCS request;
sending, by the LMF, at least one first SLPP PDU to at least one of the at least one second UE and the at least one third UE;
receiving, by the LMF, at least one second SLPP PDU, from the at least one of the at least one second UE and the at least one third UE, to estimate the location of the first UE, wherein the at least one second SLPP PDU includes the at least one first session ID;
sending, by the LMF, the location estimate of the first UE, to the at least one second UE.

2. The method as claimed in claim 1, wherein the first UE is one of the at least one second UE, and any other UE.

3. The method as claimed in claim 1, wherein the LCS request is received by at least one second UE from at least one of an application layer of the at least one second UE and any other UE.

4. The method as claimed in claim 1, wherein the LMF communicates with the at least one third UE is by using one of, a Uu link; and, the at least one second UE, via a PC5 link.

5. The method as claimed in claim 1, wherein the at least one first SLPP PDU is transmitted to the at least one of the at least one second UE and the at least one third UE, through an access and mobility management function (AMF), followed by a next generation-radio access network (NG-RAN).

6. The method as claimed in claim 1, further comprises:
receiving, by the LMF, the at least one second SLPP PDU, from the at least one of the at least one second UE and the at least one third UE, from a NG-RAN, through an AMF.

7. The method as claimed in claim 5, wherein the AMF handles a routing of the at least one first SLPP PDU to at least one of the at least one second UE and the at least one third UE, and the at least one second SLPP PDU to the LMF using at least one of correlation IDs, UE IDs and routing IDs.

8. The method as claimed in claim 1, wherein the at least one first SLPP PDU and the at least one second SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

9. A method of obtaining location of a first user equipment (UE) wherein the method comprising:
transmitting, by the at least one second UE, at least one location service (LCS) request, to a location management function (LMF);
receiving, by the at least one second UE, at least one first sidelink positioning protocol data units (SLPP PDUs), from the LMF, wherein the at least one first SLPP PDU includes at least one first session ID;
segregating, by the at least one second UE, the at least one first SLPP PDU to construct at least one third SLPP PDU; wherein segregating the at least one first SLPP PDU to the at least one third SLPP PDU, further comprises:
one of,
including, by the at least one second UE, the at least one first session ID, in the at least one third SLPP PDU;
and,
adding, by the at least one second UE, at least one second session ID, in the at least one third SLPP PDU;
and
distributing, by the at least one second UE, the at least one third SLPP PDU, to the at least one third UE;
receiving, by the at least one second UE, at least one fourth SLPP PDU, from the at least one third UE;
combining, by at least one second UE, the at least one fourth SLPP PDU, to construct at least one second SLPP PDU;
sending, by the at least one second UE, the at least one second SLPP PDU, to the LMF;
receiving, by the at least one second UE, the location estimate of the first UE, from the LMF.

10. The method as claimed in claim 9, wherein the LCS request is received by at least one second UE from one of an application layer of the at least one second UE or any other UE.

11. The method as claimed in claim 9, further comprises:
sending, by the at least one second UE, the location estimate of the first UE, to one of the application layer of the at least one second UE or any other UE.

12. The method as claimed in claim 9, wherein the first UE is one of the at least one second UE, or any other UE.

13. The method as claimed in claim 9, wherein the at least one fourth SLPP PDU contains the at least one first session ID, if the at least one third SLPP PDU includes the at least one first session ID.

14. The method as claimed in claim 9, wherein the at least one fourth SLPP PDU contains the at least one second session ID, if the at least one third SLPP PDU includes the at least one second session ID.

15. The method as claimed in claim 9, wherein the at least one second SLPP PDU is transmitted to the LMF, through a next generation-radio access network (NG-RAN), followed by an access and mobility management function (AMF).

16. The method as claimed in claim 15, wherein the AMF handles arouting of the at least one second SLPP PDU to the LMF using at least one of correlation IDs, UE IDs and routing IDs.

17. The method as claimed in claim 9, wherein the at least one first SLPP PDU, the at least one second SLPP PDU, the at least one third SLPP PDU, and the at least one fourth SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

18. A method for side link positioning (SL) and ranging to estimate the location of a user equipment (UE), the method comprising:
receiving, by at least one second UE, a ranging and SL positioning service request from one of an application layer of the at least one second UE or, any other UE;
discovering, by the at least one second UE, the at least one of at least one first SL anchor UE, at least one first SL positioning server UE, and at least one first SL located UE;
selecting, by the at least one second UE, at least one of the at least one second SL anchor UE from the at least one first SL anchor UE, at least one second SL located UE from the at least one first SL located UE, and a SL positioning server UE from at least one of the at least one first SL positioning server UE and the at least one second UE;
forwarding, by the at least one second UE, the ranging and SL positioning service request to the SL positioning server UE;
receiving, by the at least one second UE, the location estimate of the at least one UE, from the SL positioning server UE;
sending, by the at least one second UE, the location estimate of the first UE, to at least one of the first UE, any other UE, and the application layer of the at least one second UE.

19. The method as claimed in claim 18, wherein the forwarding of the ranging and SL positioning service request includes a list of at least one of the at least one second SL anchor UE, the at least one second SL located UE, and the at least one second UE.

20. The method as claimed in claim 18, wherein selecting the SL positioning server UE further comprises:
exchanging, by the SL positioning server UE, at least one SLPP PDU with the at least one of the at least one second UE, the at least one SL anchor UE and the at least one SL located UE, using a PC5 link to estimate the location of the first UE.

21. The method as claimed in claim 18, wherein the at least one location estimate of the first UE, is at least one of absolute location, relative location, and ranging information.

22. The method as claimed in claim 18, wherein the at least one SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

23. A method to enable transmission and reception of sidelink positioning reference signal, the method comprising:
one of;
receiving, by at least one positioning server, at least one request from at least one pair of UEs;
transmitting, by the at least one positioning server, at least one sequence ID, to the at least one pair of UEs;
and,
transmitting, by the at least one positioning server, at least one request to at least one first UE;
receiving, by the at least one positioning server, at least one sequence ID, from the at least one first UE;
receiving, by the at least one positioning server, at least one request from at least one second UE;
transmitting, by the at least one positioning server, the at least one sequence ID to the at least one second UE.

24. The method as claimed in claim 23, the method further comprises:
transmitting, by the at least one first UE, at least one sidelink positioning reference signal (SL PRS) using the at least one sequence ID.

25. The method as claimed in claim 23, the method further comprises:
receiving, by the at least one second UE, the at least one sequence ID,
receiving, by the at least one second UE, the at least one SL PRS,
decoding, by the at least one second UE, the at least one SL PRS, using the at least one sequence ID.

26. The method as claimed in claim 23, wherein the positioning server is at least one of a location management function (LMF) and a SL positioning server UE.

27. The method as claimed in claim 23, wherein the sequence ID is a value between 0-4095.

28. The method as claimed in claim 23, wherein the sequence ID is exchanged using at least one SLPP PDU.

29. An apparatus for obtaining location of a first user equipment (UE), the apparatus comprises:
one or more memories; and
one or more processors coupled to the memories and adapted to:
receive, by a location management function (LMF), at least one location service (LCS) request from at least one second UE connected to a network, to estimate the location of the first UE;
identify, by the LMF, at least one third UE participating in a positioning session, wherein the LMF communicates with the at least one third UE;
generate, by the LMF, at least one first sidelink positioning protocol data units (SLPP PDUs) for the at least one second UE and the at least one third UE, wherein the at least one first SLPP PDU includes at least one first session ID to the at least one LCS request;
send, by the LMF, at least one first SLPP PDU to at least one of the at least one second UE and the at least one third UE;
receive, by the LMF, at least one second SLPP PDU, from the at least one of the at least one second UE and the at least one third UE, to estimate the location of the first UE, wherein the at least one second SLPP PDU includes the at least one first session ID;
send, by the LMF, at least one location estimate of the first UE, to the at least one second UE.

30. The apparatus as claimed in claim 29, wherein the first UE is one of the at least one second UE, the at least one third UE, and any other UE.

31. The apparatus as claimed in claim 29, wherein the LCS request is received by at least one second UE from at least one of the first UE, any other UE, and an application layer of the at least one second UE.

32. The apparatus as claimed in claim 29, wherein the LMF communicates with the at least one third UE is by using one of, a Uu link and, the at least one second UE, via a PC5 link.

33. The apparatus as claimed in claim 29, wherein the at least one first SLPP PDU is transmitted to the at least one of the at least one second UE and the at least one third UE, through an access and mobility management function (AMF), followed by a next generation-radio access network (NG-RAN).

34. The apparatus as claimed in claim 29, further configured to:
receive, by the LMF, the at least one second SLPP PDU, from the at least one of the at least one second UE and the at least one third UE, from an NG-RAN, through the AMF.

35. The apparatus as claimed in claim 33, wherein the AMF handles a routing of the at least one first SLPP PDU to at least one of the at least one second UE and the at least one third UE, and the at least one second SLPP PDU to the LMF using at least one of correlation IDs, UE IDs and routing IDs.

36. The apparatus as claimed in claims 29, wherein the at least one first SLPP PDU and the at least one second SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

37. An apparatus for obtaining location of a user equipment (UE), the apparatus comprises:
one or more memories; and
one or more processors coupled to the memories and adapted to:
transmit, by the at least one second UE, at least one location service (LCS) request, to a location management function (LMF);
receive, by the at least one second UE, at least one first sidelink positioning protocol data units (SLPP PDUs), from the LMF, wherein the at least one first SLPP PDU includes at least one first session ID;
segregate, by the at least one second UE, the at least one first SLPP PDU to construct at least one third SLPP PDU; wherein segregating the at least one first SLPP PDU to the at least one third SLPP PDU, further comprises:
one of,
include, by the at least one second UE, the at least one first session ID, in the at least one third SLPP PDU;
and,
add, by the at least one second UE, at least one second session ID, in the at least one third SLPP PDU;
and
distribute, by the at least one second UE, the at least one third SLPP PDU, to the at least one third UE;
receive, by the at least one second UE, at least one fourth SLPP PDU, from the at least one third UE;
combine, by at least one second UE, the at least one fourth SLPP PDU, to construct at least one second SLPP PDU;
send, by the at least one second UE, the at least one second SLPP PDU, to the LMF;
receive, by the at least one second UE, at least one location estimate of the first UE, from the LMF.

38. The apparatus as claimed in claim 37, wherein the LCS request is received by at least one second UE from at least one of an application layer of the at least one second UE and any other UE.

39. The apparatus as claimed in claim 37, further configured to:
send, by the at least one second UE, the at least one location estimate of the first UE, to one of the application layer of the at least one second UE and any other UE the application layer of the at least one second UE.

40. The apparatus as claimed in claim 37, wherein the first UE is one of the at least one second UE, and any other UE.

41. The apparatus as claimed in claim 37, wherein the at least one fourth SLPP PDU contains the at least one first session ID, if the at least one third SLPP PDU includes the at least one first session ID.

42. The apparatus as claimed in claim 37, wherein the at least one fourth SLPP PDU contains the at least one second session ID, if the at least one third SLPP PDU includes the at least one second session ID.

43. The apparatus as claimed in claim 37, wherein the at least one second SLPP PDU is transmitted to the LMF, through a next generation-radio access network (NG-RAN), followed by an access and mobility management function (AMF).

44. The apparatus as claimed in claim 37, wherein the AMF handles a routing of the at least one second SLPP PDU to the LMF using at least one of correlation IDs, UE IDs and routing IDs.

45. The apparatus as claimed in claim 37, wherein the at least one first SLPP PDU, the at least one second SLPP PDU, the at least one third SLPP PDU, and the at least one fourth SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

46. An apparatus for side link positioning (SL) and ranging to estimate the location of at least one first user equipment (UE), the apparatus comprises:
one or more memories; and
one or more processors coupled to the memories and adapted to:
receive, by at least one second UE, a ranging and SL positioning service request from at least one of an application layer of the at least one second UE or any other UE;
discover, by the at least one second UE, the at least one of at least one first SL anchor UE, at least one first SL positioning server UE, and at least one first SL located UE;
select, by the at least one second UE, at least one of the at least one second SL anchor UE from the at least one first SL anchor UE, at least one second SL located UE from the at least one first SL located UE, and a SL positioning server UE from at least one of the at least one first SL positioning server UE and the at least one second UE;
forward, by the at least one second UE, the ranging and SL positioning service request to the SL positioning server UE;
receive, by the at least one second UE, at least one location estimate of the at least one UE, from the SL positioning server UE;
send, by the at least one second UE, the at least one location estimate of the first UE, to at least one of the first UE, any other UE, and the application layer of the at least one second UE.

47. The apparatus as claimed in claim 46, wherein the forwarding of the ranging and SL positioning service request includes a list of at least one of the at least one second SL anchor UE, the at least one second SL located UE, and the at least one second UE.

48. The apparatus as claimed in claim 46, wherein selecting the SL positioning server UE further configured to:
exchange, by the SL positioning server UE, at least one SLPP PDU with the at least one of the at least one second UE, the at least one SL anchor UE and the at least one SL located UE, using a PC5 link to estimate the location of the first UE.

49. The apparatus as claimed in claim 46, wherein the at least one location estimate of the first UE, is at least one of absolute location, relative location, and ranging information.

50. The apparatus as claimed in claim 46, wherein the at least one SLPP PDU includes at least one of SLPP RequestCapabilities, SLPP ProvideCapabilities, SLPP RequestAssistanceData, SLPP ProvideAssistanceData, SLPP RequestLocationInformation, SLPP ProvideLocationInformation, SLPP Error, and SLPP Abort messages.

51. An apparatus to enable transmission and reception of sidelink positioning reference signal, the apparatus comprises:
one or more memories; and
one or more processors coupled to the memories and adapted to perform:
one of;
receive, by at least one positioning server, at least one request from at least one pair of UEs;
transmit, by the at least one positioning server, at least one sequence ID, to the at least one pair of UEs;
and, transmit, by the at least one positioning server, at least one request to at least one first UE;
receive, by the at least one positioning server, at least one sequence ID, from the at least one first UE;
receive, by the at least one positioning server, at least one request from at least one second UE;
transmit, by the at least one positioning server, the at least one sequence ID to the at least one second UE.

52. The apparatus as claimed in claim 51, the apparatus further configured to:
transmit, by the at least one first UE, at least one sidelink positioning reference signal (SL PRS) using the at least one sequence ID.

53. The apparatus as claimed in claim 51, apparatus further configured to:
receive, by the at least one second UE, the at least one sequence ID,
receive, by the at least one second UE, the at least one SL PRS,
decode, by the at least one second UE, the at least one SL PRS, using the at least one sequence ID.

54. The apparatus as claimed in claim 51, wherein the positioning server is at least one of a location management function (LMF) and a SL positioning server UE.

55. The apparatus as claimed in claim 51, wherein the sequence ID is a value between 0-4095.

56. The apparatus as claimed in claim 51, wherein the sequence ID is exchanged using at least one SLPP PDU.
